(19) United States
(12) Patent Application Publication
(10) Pub. No.: US 2010/0084922 A1
(43) Pub. Date: Apr. 8, 2010

(54) Three-Level Inverter

(75) Inventors: Bernard Michel GOLLENTZ, Soultz (FR); Virginie Guennegues, Belfort (FR)

Correspondence Address: Davidson, Davidson & Kappel, LLC, 485 7th Avenue, 14th Floor, New York, NY, 10018, US

(73) Assignee: CONVERTEAM TECHNOLOGY LTD., Rugby (GB)

(21) Appl. No.: 12/496,182

(22) Filed: Jul. 1, 2009

(30) Foreign Application Priority Data
Jul. 1, 2008 (FR) 08 54450

(51) Int. Cl. H02J 3/00

(52) U.S. Cl. 307/78; 307/82

(57) ABSTRACT

The present invention provides a three-level inverter including first and second direct voltage generators connected in series, each between a common center point and first and second end points, and first and second switching arms. Each of the first and second switching arms are connected between a respective one of the first and second end points and an output point and include at least one IGBT transistor. The IGBT transistors of the first and second switching arms are in series between the first and second end points. Each of the IGBT transistors includes an antiparallel-connected diode. The three-level inverter also includes a third switching arm which includes two IGBT transistors connected head-to-tail. Each head to tail transistor includes an antiparallel-connected diode.

Priority is claimed to French Application No. 08 54450 filed on Jul. 1, 2008 and hereby incorporated by reference herein.

The present invention is related to a three-level inverter, and more particularly such an inverter including two direct voltage generators connected in series, each between a common center point and an end point, and two first switching arms, each of the two first switching arms being connected between one of the end points and an output point and including two IGBT transistors in series such that the four IGBT transistors of the two switching arms are in series between the two end points, each of the IGBT transistors includes an antiparallel-connected diode.

### BACKGROUND OF THE INVENTION

Several inverter structures of this type are already known.

The document FR-A-2437102 describes an inverter of the NPC type (Neutral Point Clamped) in which diodes connected to a center point effect the distribution of the input voltage between the transistors in the blocked state of the two first switching arms.

This structure, however, has the drawback of adding the losses to the different transistors of the two first switching arms. At the outer transistors (located on the side of the end points), the losses are both of switching and conduction, while at the inner transistors (located on the side of the output point), the losses are of conduction owing to the fact that these latter transistors do not switch in the more usual mode of operation (i.e., power transited from the direct bus to the inductive load).

Another type of structure such as that mentioned above is known. The document U.S. Pat. No. 5,737,201 describes a series multi-cellular converter in which a capacitor is connected between the points of junction between the two transistors of each of the first switching arms. For technological reasons, such structures are however generally not very economic.

### SUMMARY OF THE INVENTION

The present invention aims to remedy these drawbacks.

More particularly, an object of the present invention is to provide a new three-level converter topology which makes it possible either to double the switching frequency at constant current, or to double the current at constant switching frequency.

The present invention provides a three-level inverter including two direct voltage generators connected in series, each between a common center point and an end point, and two first switching arms. Each of the two first switching arms is connected between one of the end points and an output point. Each of the two first switching arms includes two IGBT transistors in series such that the four IGBT transistors of the two switching arms are in series between the two end points. Each of the IGBT transistors has an antiparallel-connected diode. The inverter further includes a third switching arm including two IGBT transistors connected head-to-tail, each transistor having an antiparallel-connected diode. The three-level inverter may also include means for effecting the simultaneous switching of the two IGBT transistors in series of each of the two first switching arms.

In a particular preferred embodiment, the means for effecting the simultaneous switching of the two IGBT transistors in series of each of the two first switching arms include means for processing a corrective control signal of one of the two IGBT transistors in series, dependent on the time evolution difference of the voltage at the conduction terminals of the two IGBT transistors in series.

Means for processing a corrective control signal of one of the two IGBT transistors in series is known per se and described in the document FR-A-2900289, hereby incorporated by reference herein.

### BRIEF DESCRIPTION OF THE DRAWINGS

A description will now be given, by way of non-limiting example, of a particular embodiment of the invention, with reference to the appended schematic drawings, in which:

FIG. 1 is a circuit diagram of an inverter according to the present invention;

FIGS. 2a to 2f illustrate the operation of the inverter of FIG. 1; and

FIG. 3 illustrates the operation of the inverter of FIG. 1 compared with that of a conventional 3-level inverter.

### DETAILED DESCRIPTION OF A PREFERRED EMBODIMENT

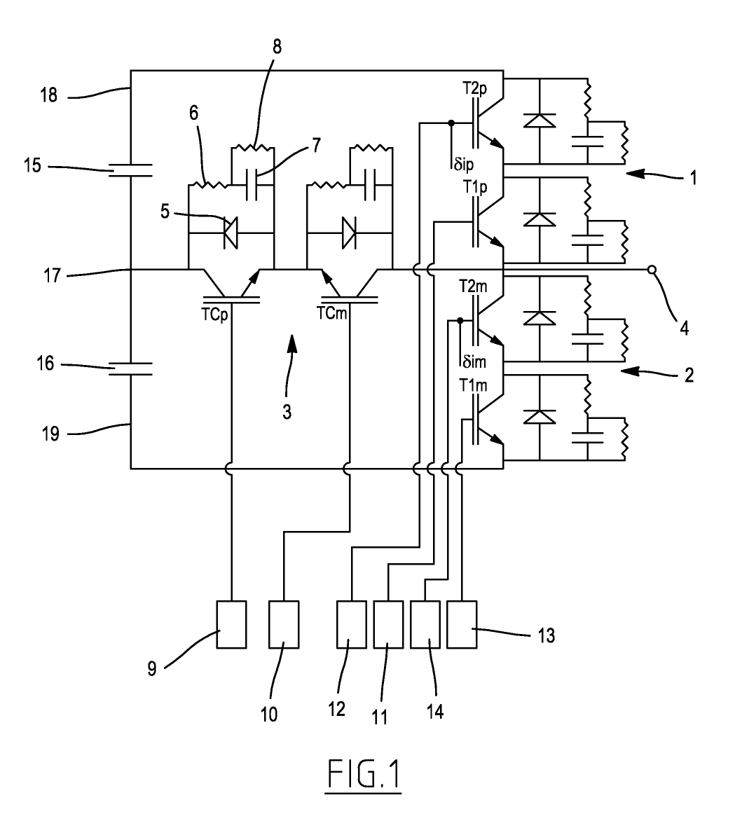

As shown in FIG. 1, the inverter includes two lateral arms 1 and 2 and a central arm 3.

The two lateral arms 1 and 2 are identical and each include two IGBTs, respectively T1p, T2p and T1m, T2m, connected in series and connected in the same direction. The arms 1 and 2 are themselves both connected to an output point 4 such that the four IGBTs are in series and connected in the same direction.

The central arm 3 itself includes two IGBTs TCp, TCm mounted head-to-tail. The central arm is also connected at one of its ends to the output point 4.

A diode 5 is antiparallel-mounted on each IGBT.

In the embodiment shown here, provision is further made for a circuit including a resistor 6 in series with a capacitor 7 and mounted in parallel on each diode 5, a second resistor 8 being mounted in parallel on the capacitor 7. The circuits make it possible to avoid different tail currents on the opening of the IGBTs. It is also possible to provide such circuits only in parallel on the IGBTs, T1p, T2p, T1m and T2m, with the exclusion of the IGBTs, TCp and TCm.

The IGBTs, TCp and TCm, are controlled by excitation circuits 9 and 10 respectively, and the IGBTs, T1p, T2p, T1m and T2m, are controlled by excitation circuits 11, 12, 13 and 14 respectively.

Two capacitors 15 and 16 forming voltage sources are connected in series at a center point 17. The arms of the inverter are connected in the following manner to these capacitors.

The end of the arm 3 opposed to the output point 4 is connected to the point 17. The ends of the arms 1 and 2 opposed to the output point 4 are connected to the end points 18 and 19 respectively of the assembly of capacitors 15 and 16.

In order that the IGBTs, T1p and T2p, on the one hand, and T1m and T2m on the other hand, switch simultaneously, corrective control signals, respectively δip, δim, are applied to the IGBTs, T2p and T2m, as described in the aforesaid document FR-A-2900289.

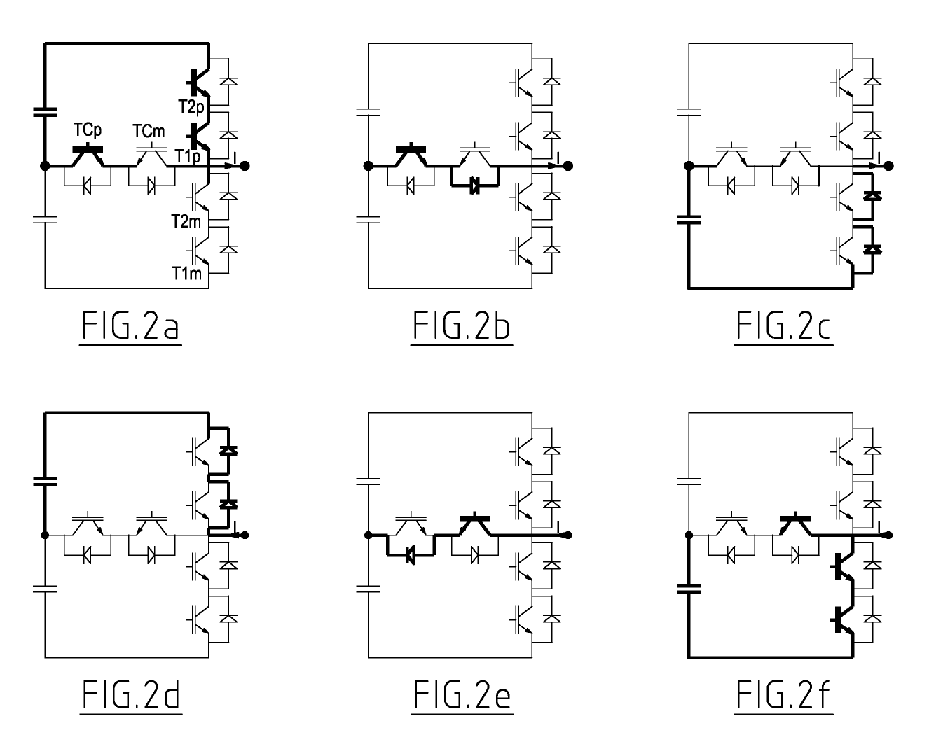

The conduction sequence of the IGBTs and the diodes can be seen in FIG. 2.

T1p and T2b always switch together, the same as T1m and T2m. When T1p and T2p are closed, TCm is open and vice versa, when T1m and T2m are closed, TCp is open.

When an output voltage of 1 is desired, T1p and T2p and also TCp are closed. TCp closes when no current passes through it, so that no loss is associated therewith. TCm behaves in the same manner in the case of a negative charge current.

If Vdc/2 is the voltage at the terminals of each of the capacitors 15 and 16, the switching voltage of T1p and T2p is equal to Vdc/4 unlike in a conventional NPC 3-level inverter wherein this switching voltage is Vdc/2. The switching losses in these components are therefore divided by 2, thereby making it possible to double the switching frequency without increasing the losses, and therefore to improve the output waveforms.

The SOA (Safe Operating Area) is improved, since the switching voltage is reduced.

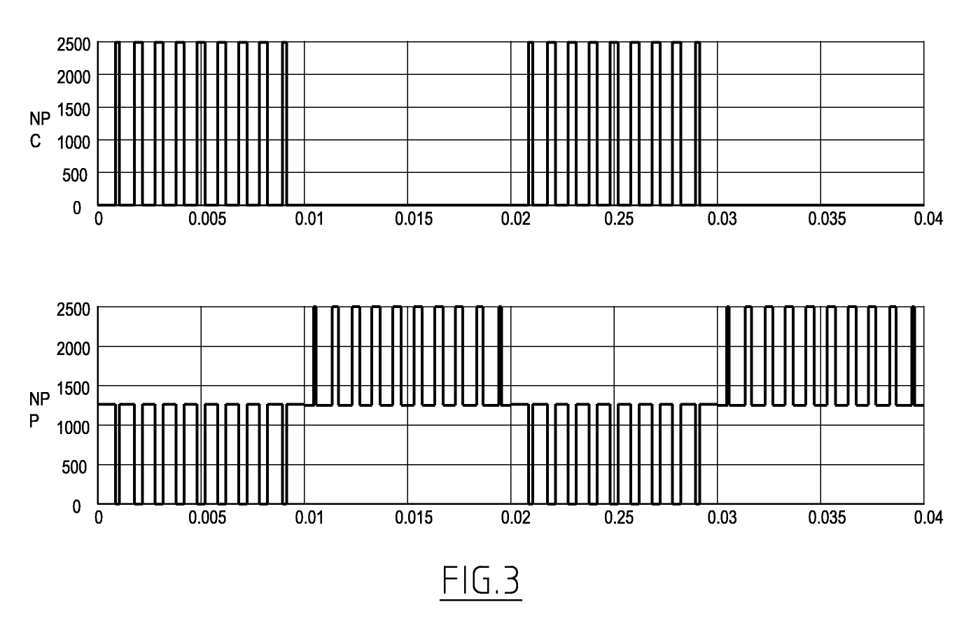

In FIG. 3 can be seen the voltages at the terminals of the IGBT T2p in the case of a conventional NPC inverter (top) and in the case of the invention (bottom). The switched voltage is half as high in the present invention. However, the output waveforms are the same.

When T1p, T2p and TCp are closed and T1m, T2m and TCm are open, the output voltage is 1, or in other words, the output voltage is equal to Vdc/2.

When T1p, T2p, T1m and T2m are open and TCp and TCm are closed, the output voltage is equal to 0.

When T1m, T2m and TCm are closed, while T1p, T2p and TCp being open, the output voltage is −1, or in other words, the output voltage is equal to −Vdc/2.

Central arm 3 forms a bidirectional switch adapted to control the 0 level of the output voltage. Central arm 3 is controlled by the excitation circuits 9 and 10 such that the output voltage is at 0 level, i.e. substantially equal to 0, during a non-negligible amount of time. In other words, the 0 level of the output voltage is not a transition state. The output voltage is equal to 0 during a period which is for instance in average substantially equal to the duration of the levels 1 or −1 of the output voltage.

The control signals for the IGBTs TCp, TCm, T1p, T2p, T1m and T2m delivered by the excitation circuits 9, 10, 11, 12, 13, 14, respectively, thus allow one to obtain three stable output levels −1, 0 and 1, corresponding to an output voltage equal to −Vdc/2, 0 and Vdc/2, respectively, thus representing a three-level inverter.

What is claimed is:

1. A three-level inverter comprises:
a first and a second direct voltage generator connected in series, each between a common center point and first and second end points,
a first and a second switching arm, each of the first and second switching arms being connected between a respective one of the first and second end points and an output point, each of the first and second switching arms including at least one IGBT transistor, the at least one IGBT transistors of the first and second switching arms being in series between the first and second end points, each of the at least one IGBT transistors including an antiparallel-connected diode; and
a third switching arm including two IGBT transistors connected head-to-tail, each IGBT transistor having an antiparallel-connected diode.

2. The three-level inverter according to claim 1, wherein each of the first and second switching arms includes two IGBT transistors in series, the three-level inverter further comprising means for effecting the simultaneous switching of the two IGBT transistors in series of each of the first and second switching arms.

3. The three-level inverter according to claim 2, wherein the means for effecting the simultaneous switching of the two IGBT transistors in series of each of the first and second switching arms includes means for processing a corrective control signal for one of the two IGBT transistors in series, dependent on the time evolution difference of the voltage at conduction terminals of the two IGBT transistors in series.

4. The three-level inverter according to claim 2, wherein the means for effecting the simultaneous switching of the two IGBT transistors in series include excitation circuits.
